(19) United States
(12) Patent Application Publication
(10) Pub. No.: US 2010/0195989 A1
(43) Pub. Date: Aug. 5, 2010

(54) IMAGE REPRODUCING APPARATUS AND IMAGE REPRODUCING METHOD

(75) Inventors: Daisuke Amano, Osaka (JP); Hitomi Ueda, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/699,378

(22) Filed: Feb. 3, 2010

(30) Foreign Application Priority Data
Feb. 5, 2009 (JP) 2009-025339

(51) Int. Cl. H04N 7/26

(52) U.S. Cl. 386/124; 386/E05.003

(57) ABSTRACT

An image reproducing apparatus includes: a memory which stores a plurality of motion picture files; an image reproducing controller which performs an analyzing operation to analyze the motion picture file; a first buffer which stores a result of analysis about the motion picture file, wherein the controller performs a reading operation to read out image data from the motion picture file stored in the memory; and a second buffer which stores the image data, wherein the controller reproduces the image data stored in the second buffer, based on the result of analysis stored in the first buffer. During the reproduction of the image data, the analyzing operation starts to analyze the motion picture file and the reading operation starts to read out the image data.

This nonprovisional application is based on Japanese Patent Application No. 2009-025339 filed on Feb. 5, 2009 with the Japan Patent Office, the entire contents of which are hereby incorporated by reference.

### BACKGROUND OF THE INVENTION

1. Field of the Invention

The present invention relates to an image reproducing apparatus. In particular, the present invention relates to an image reproducing apparatus and an image reproducing method for continuously reproducing a plurality of motion picture files recorded in a memory.

2. Description of the Related Art

In an image reproducing apparatus for reproducing motion picture data in a motion picture file recorded in an external memory or the like, occasionally, it is desirable to continuously and seamlessly reproduce a plurality of pieces of motion picture data. In this case, it is desirable to perform operations for reproducing previous motion picture data and then continuously reproducing subsequent motion picture data in one reproduction process. As a technique of realizing the seamless reproduction, there has been known a method for recording information for continuous reproduction together with motion picture data in an external memory, and continuously reproducing the motion picture data, based on the information.

In a case of recording motion picture data obtained by an imaging apparatus, for example, a motion picture file in MP4 format, which is one of file formats for storing compressed motion picture data in MPEG-4 format, is occasionally recorded in a memory. In order to reproduce the motion picture file recorded in the memory, it is necessary to open the motion picture file, analyze header information, video data information and audio data information in the motion picture file, and reproduce motion picture data, based on the analyzed information.

Conventionally, there has been known the technique of recording the information for continuous reproduction together with the motion picture data obtained by the imaging operation and continuously reproducing the motion picture data by referring to the information. However, there has been known neither a technique in a case of continuously reproducing motion picture data which is not recorded as a target of continuous reproduction when being obtained by an imaging operation nor a technique in a case of continuously reproducing motion picture data recorded using a different recording apparatus. Hence, it is necessary to open the motion picture file, analyze the information in the motion picture file, and reproduce the motion picture data, based on the information, as described above.

For example, an apparatus needs to execute the following operations in order to continuously reproduce two motion picture files. As described above, first, the apparatus opens the first motion picture file, analyzes information in the first motion picture file, and starts to reproduce motion picture data in the first motion picture file. Upon completion of the reproduction of the first motion picture file, next, the apparatus opens the second motion picture file, and starts to reproduce motion picture data in the second motion picture file. As a result, a time lag occurs between the completion of reproduction of the first motion picture data and the start of reproduction of the second motion picture data. In other words, it is impossible to seamlessly reproduce the motion picture data. Consequently, a user fails to smoothly watch a plurality of motion picture files to be reproduced continuously, and occasionally feels stress.

### SUMMARY OF THE INVENTION

According to one aspect of the present invention, there is provided an image reproducing apparatus which continuously reproduces a plurality of image data in a plurality of motion picture files each including at least header information and the image data. The image reproducing apparatus includes: a memory which stores the plurality of motion picture files; an image reproducing controller which performs an analyzing operation to analyze the motion picture file stored in the memory, based on the header information; a first buffer which stores a result of analysis about the motion picture file, wherein the image reproducing controller performs a reading operation to read out the image data from the motion picture file stored in the memory; and a second buffer which stores the read out image data, wherein the image reproducing controller performs a reproducing operation to reproduce the image data stored in the second buffer, based on the result of analysis stored in the first buffer, wherein the image reproducing controller performs a timing operation to control a timing to start the analysis of the motion picture file and a timing to start the readout of the image data. The timing operation includes control of the analyzing operation and the reading operation such that during reproduction of the image data by the reproducing operation, the analyzing operation starts to analyze the motion picture file including the image data to be reproduced next and the reading operation starts to read out the image data.

Preferably, the image reproducing controller performs the analyzing operation, the reading operation and the reproducing operation in parallel.

Preferably, the first buffer is a ring buffer.

According to another aspect of the present invention, there is provided an image reproducing apparatus which continuously reproduces a plurality of image data in a plurality of motion picture files each including at least header information and the image data. The image reproducing apparatus includes: a memory which stores the plurality of motion picture files; an image reproducing controller which performs an analyzing operation to analyze the motion picture file stored in the memory, based on the header information; a first buffer which stores a result of analysis about the motion picture file, wherein the image reproducing controller performs a reading operation to read out the image data from the motion picture file stored in the memory; a second buffer which stores the read out image data, wherein the image reproducing controller performs i) reproducing operation to reproduce the image data stored in the second buffer, based on the result of analysis stored in the first buffer; ii) a receiving operation to receive a command to continuously reproduce the plurality of motion picture files; and iii) a timing operation to control a timing to start the analysis of the motion picture file and a timing to start the readout of the image data. The timing operation includes control of the analyzing operation and the reading operation such that the analyzing operation starts to analyze the plurality of motion picture files including the plurality of image data to be reproduced continuously and the reading operation starts to read out the image data in a sequential manner, based on a capacity of the first buffer or the second buffer, in response to the reception of the command.

Preferably, the image reproducing controller performs the analyzing operation, the reading operation and the reproducing operation in parallel.

Preferably, the first buffer is a ring buffer.

According to still another aspect of the present invention, there is provided an image reproducing method in an image reproducing apparatus including a memory and a processor. The image reproducing method includes the steps of: storing, in the memory, a plurality of motion picture files each including at least header information and image data; analyzing, by the processor, the motion picture file stored in the memory, based on the header information; storing, by the processor, a result of analysis about the motion picture file in a first buffer; reading out, by the processor, the image data from the motion picture file stored in the memory; storing, by the processor, the read out image data in a second buffer; reproducing, by the processor, the image data stored in the second buffer, based on the result of analysis stored in the first buffer; and while reproducing the image data, starting to analyze, by the processor, the motion picture file including the image data to be reproduced next and starting to read out the image data.

Preferably, the processor executes the step of analyzing, the step of reading and the step of reproducing in parallel.

Preferably, the first buffer is a ring buffer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an imaging apparatus which is one implementable example of an image reproducing apparatus according to the present invention.

FIG. 2 is a diagrammatic illustration partially showing an interior of an SDRAM in the imaging apparatus shown in FIG. 1.

FIG. 3 is a diagrammatic illustration partially showing a data sequence in the SDRAM in the implementable example.

FIG. 4 is a diagrammatic illustration partially showing another data sequence in the SDRAM in the implementable example.

FIG. 5 is a diagrammatic illustration partially showing still another data sequence in the SDRAM in the implementable example.

FIG. 6 is a flowchart showing one example of a procedure of a file reproduction task in the implementable example.

FIG. 7 is a flowchart showing one example of a procedure of an index management task in the implementable example.

FIG. 8 is a flowchart showing one example of a procedure of a data read task in the implementable example.

### DESCRIPTION OF THE PREFERRED. EMBODIMENTS

With reference to the drawings, detailed description will be given of preferred embodiments of the present invention. In the drawings, identical or corresponding components are shown with an identical reference sign and description thereof will not be given repeatedly.

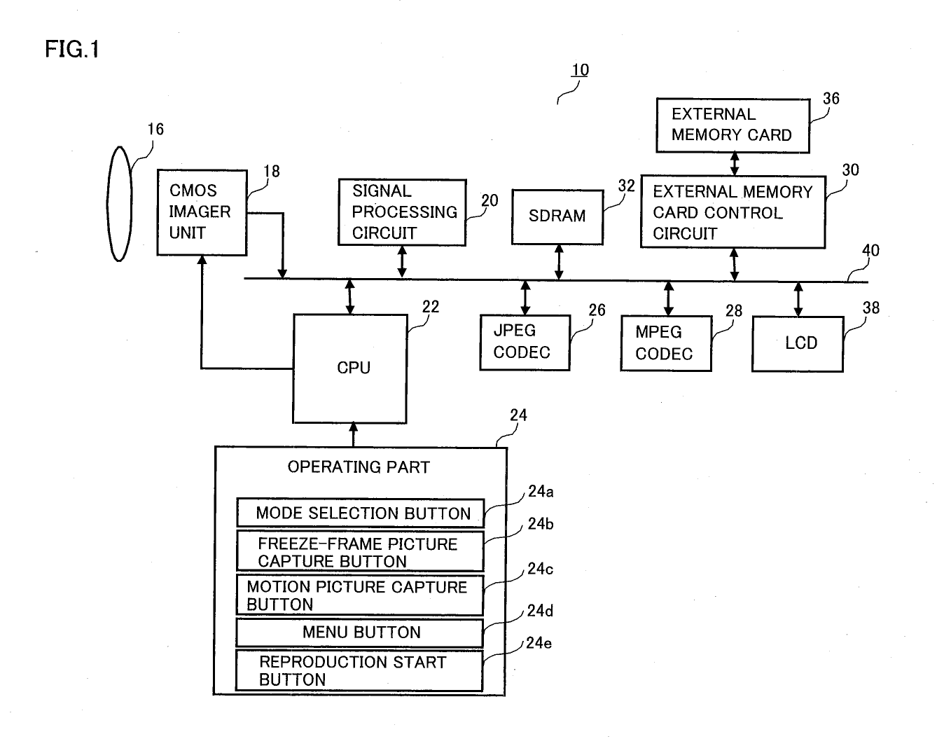

With reference to the drawings, hereinafter, specific description will be given of a digital camera 10 which is one implementable example of an image reproducing apparatus according to the present invention. FIG. 1 is a block diagram showing digital camera 10 in this implementable example.

Digital camera 10 includes an optical lens 16 and a diaphragm (not shown). An optical image of a subject is captured into a CMOS imager unit 18 through optical lens 16 and the diaphragm each controlled by a motor drive unit (not shown) in accordance with a command from a CPU 22. Then, digital imaging signals corresponding to one frame are output from CMOS imager unit 18, based on a capturing pulse given from a timing generator (not shown) connected to CPU 22. Herein, CMOS imager unit 18 amplifies electric charge accumulated in each pixel, reads out the digital imaging signal from each pixel through use of a line, and performs correlated double sampling, gain adjustment, clamping and A/D conversion on the digital imaging signal. The digital imaging signal subjected to the processing has any one of an R color signal, a G color signal and a B color signal for each pixel, and is temporarily stored in an SDRAM 32 via a bus 40 by the control of CPU 22.

The digital imaging signal, which is temporarily stored in SDRAM 32, is input to a signal processing circuit 20 by the control of CPU 22. Signal processing circuit 20 performs color separation on the digital imaging signal input thereto and, further, performs YUV conversion on the digital imaging signal to convert the digital imaging signal into a YUV signal. Then, the digital image signal obtained by the conversion in signal processing circuit 20 is stored again in SDRAM 32 via bus 40. In this implementable example, the process of converting the digital imaging signal output from CMOS imager unit 18 into the digital image signal in signal processing circuit 20 and storing the digital image signal in SDRAM 32 is defined as an image capture process.

Moreover, the digital image signal, which is stored in SDRAM 32, is output to an LCD 38 by the control of CPU 22. LCD 38 includes an LCD driver (not shown). The LCD driver converts the YUV signal into an RGB signal, and causes LCD 38 to display an image signal based on the digital image signal. In this implementable example, the process of displaying the digital image signal, which is stored in SDRAM 32, as the image signal on LCD 38 is defined as a display process.

An operating unit 24 has a mode selection button 24a, a freeze-frame picture capture button 24b, a motion picture capture button 24c, a menu button 24d and a reproduction start button 24e. These buttons may be hardware buttons. Alternatively, these buttons may be software buttons displayed on LCD 38. A user presses mode selection button 24a to select one of an image capture mode and a reproduction mode in digital camera 10.

Herein, when the user presses mode selection button 24a to select the image capture mode, the image capture process is repeatedly executed based on a predetermined resolution and a predetermined frame rate. Then, the display process is sequentially executed, so that a through image is displayed on LCD 38.

In the state in which the through image is displayed, when the user presses the freeze-frame picture capture button 24b, the imaging process is executed based on a resolution for capturing a freeze-frame picture. When the imaging process is executed, the digital image signal, which is stored in SDRAM 32, is input to a JPEG codec 26 by the control of CPU 22. In JPEG codec 26, the digital image signal is subjected to JPEG compression, and compressed freeze-frame picture data thus obtained is stored again in SDRAM 32. Then, an external memory card control circuit 30 to be controlled by CPU 22 records the compressed freeze-frame picture data stored in SDRAM 32, as a freeze-frame picture file having a JPEG file structure, in an external memory card 36. The JPEG file structure involves a start marker, an end marker, header information, a plurality of segments, and freeze-frame picture data. The header information contains thumbnail image data. The series of operations for recording the freeze-frame picture file in the imaging process is defined as a freeze-frame picture capture process.

In the state in which the through image is displayed, moreover, when the user presses motion picture capture button 24c, the imaging process is repeatedly executed based on a resolution and a frame rate for capturing a motion picture. Then, when the imaging process is executed, the digital image signal, which is stored in SDRAM 32, is sequentially input to an MPEG codec 28 by the control of CPU 22. In MPEG codec 28, the digital image signal is subjected to MPEG-4 compression, and compressed motion picture data thus obtained is stored again in SDRAM 32. Then, external memory card control circuit 30 controlled by CPU 22 sequentially transfers the compressed motion picture data stored in SDRAM 32 to external memory card 36, and thereby records the compressed motion picture data, as a motion picture file having an MP4 file structure, in external memory card 36. The MP4 file structure involves header information, and video data information and audio data information each concerning the compressed motion picture data. The header information contains thumbnail image data. The series of operations for recording the motion picture file in the imaging process is defined as a motion picture capture process.

When the user presses mode selection button 24a to select the reproduction mode and then presses reproduction start button 24e, CPU 22 controls external memory card control circuit 30 to read out the header information in the latest freeze-frame picture file or motion picture file recorded in external memory card 36. CPU 22 determines whether or not the file thus read out can be reproduced, i.e., whether or not the file is corrupt, and also determines whether the file thus read out is a JPEG format file or an MP4 format file. If the file can be reproduced, CPU 22 analyzes the format of the file, and temporarily stores the compressed freeze-frame picture data or the compressed motion picture data in SDRAM 32. CPU 22 allows JPEG codec 26 or MPEG codec 28 to extend the data, and also causes LCD 38 to display the image signal based on the digital extended image signal. The series of operations for reading out the information from the freeze-frame picture file or the motion picture file in the display process is defined as a normal reproduction process.

The reproduction mode includes a normal reproduction mode for performing the normal reproduction process, and a motion picture continuous reproduction mode for continuously reproducing only the plurality of motion picture files stored in external memory card 36. These modes are switched in such a manner that the user presses menu button 24d of operating unit 24.

Moreover, the motion picture continuous reproduction mode includes a sequential motion picture continuous reproduction mode for performing motion picture continuous reproduction from the oldest motion picture file to the latest motion picture file in sequence, a fast-forward motion picture continuous reproduction mode for performing fast-forward motion picture continuous reproduction from the oldest motion picture file to the latest motion picture file, and a backward motion picture continuous reproduction mode for performing backward motion picture continuous reproduction from the latest motion picture file to the oldest motion picture file. These modes are switched in such a manner that the user presses menu button 24d of operating unit 24.

In this implementable example, description will be given of operations of digital camera 10 in the sequential motion picture continuous reproduction mode.

In the state in which the sequential motion picture continuous reproduction mode is selected, when the user presses reproduction start button 24e, CPU 22 executes a sequential motion picture continuous reproduction process. In order to realize the sequential motion picture continuous reproduction process, CPU 22 needs to execute a plurality of tasks in parallel. Therefore, digital camera 10 is equipped with a multi-task OS. Both the reproduction process in the fast-forward motion picture continuous reproduction mode and the reproduction process in the backward motion picture continuous reproduction mode are also realized in such a manner that CPU 22 executes a plurality of tasks in parallel.

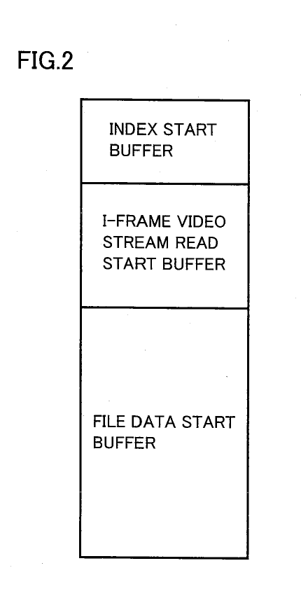

Herein, the plurality of tasks for executing the sequential motion picture continuous reproduction process, i.e., a file reproduction task, an index management task and a data read task will be described in detail later. With reference to FIGS. 1 and 2, first, detailed description will be given of the sequential motion picture continuous reproduction process.

In the state in which the sequential motion picture continuous reproduction mode is selected, when the user presses reproduction start button 24e, CPU 22 controls external memory card control circuit 30, detects the oldest motion picture file recorded in external memory card 36, and reads out header information from the motion picture file (file open). Next, CPU 22 determines whether or not the motion picture file can be reproduced, i.e., whether or not the motion picture file is an MP4 format file, based on the header information. If the motion picture file can be reproduced, CPU 22 analyzes the format of the motion picture file to write index information in the motion picture file into an index start buffer (shown in FIG. 2) in SDRAM 32. The index information contains an index number (number information indicating a reproduction order), offset information (an address indicating a position of external memory card 36 where motion picture data in a motion picture file is stored), file handler information (a reference number for reading/writing a file), a data length (a motion picture data size).

Moreover, CPU 22 sequentially writes only an I-frame in the motion picture file into an I-frame video stream read start buffer (shown in FIG. 2) in SDRAM 32, in parallel with the index information write process. In this implementable example, compressed motion picture data in the motion picture file is data obtained by performing MPEG-4 compression on digital image signals in continuous frames, and is processed on a GOP (Group of Pictures) basis based on an aggregation of the plurality of frames. In this implementable example, 10 frames are defined as one GOP. In one GOP, the first frame of the 10 frames is configured as an I picture, and the remaining nine frames are configured as a P picture.

The I-frame data stored in the I-frame video stream read start buffer is mainly used in the reproduction process in the forward motion picture continuous reproduction mode for reproducing only the I-frame data. The I-frame data write process is employed in the sequential motion picture continuous reproduction mode on grounds that, when the forward motion picture continuous reproduction mode is selected during the reproduction in the sequential motion picture continuous reproduction mode, the sequential motion picture continuous reproduction mode is quickly switched to the forward motion picture continuous reproduction mode without performing the process of writing the index information again.

Moreover, CPU 22 sequentially writes video data information (GOP basis) and audio data information each concerning the compressed motion picture data in the motion picture file into a file data start buffer (shown in FIG. 2) in SDRAM 32, in parallel with the index information write process and the I-frame data write process. Herein, each of the index start buffer, the I-frame video stream read start buffer and the file data start buffer is a ring buffer allocated in SDRAM 32, and data is repeatedly written into each buffer on a data block basis.

In the state in which the sequential motion picture continuous reproduction mode is selected, when the user presses reproduction start button 24e, i.e., when the user inputs a sequential motion picture continuous reproduction command, CPU 22 sequentially executes not only the process of opening the oldest motion picture file and then writing the information into the relevant buffer, but also a process of opening the plurality of motion picture files to be reproduced next and then writing information into the relevant buffer. Herein, the number of motion picture files as a target of the process of writing the information into the relevant buffer depends on a capacity of SDRAM 32. When the capacity of SDRAM 32 is large, the number of writing target motion picture files increases. On the other hand, when the capacity of SDRAM 32 is small, the number of writing target motion picture files decreases.

When the index information in the motion picture file is written into the index start buffer by a predetermined number which depends on the capacity of SDRAM 32, CPU 22 reproduces the compressed motion picture data based on the oldest motion picture file recorded in the file start buffer. More specifically, CPU 22 controls MPEG codec 28 to extend the compressed motion picture data, based on the index information in the index start buffer. CPU 22 stores the digital extended image signal in SDRAM 32 again, and causes LCD 38 to display an image signal based on the digital extended image signal.

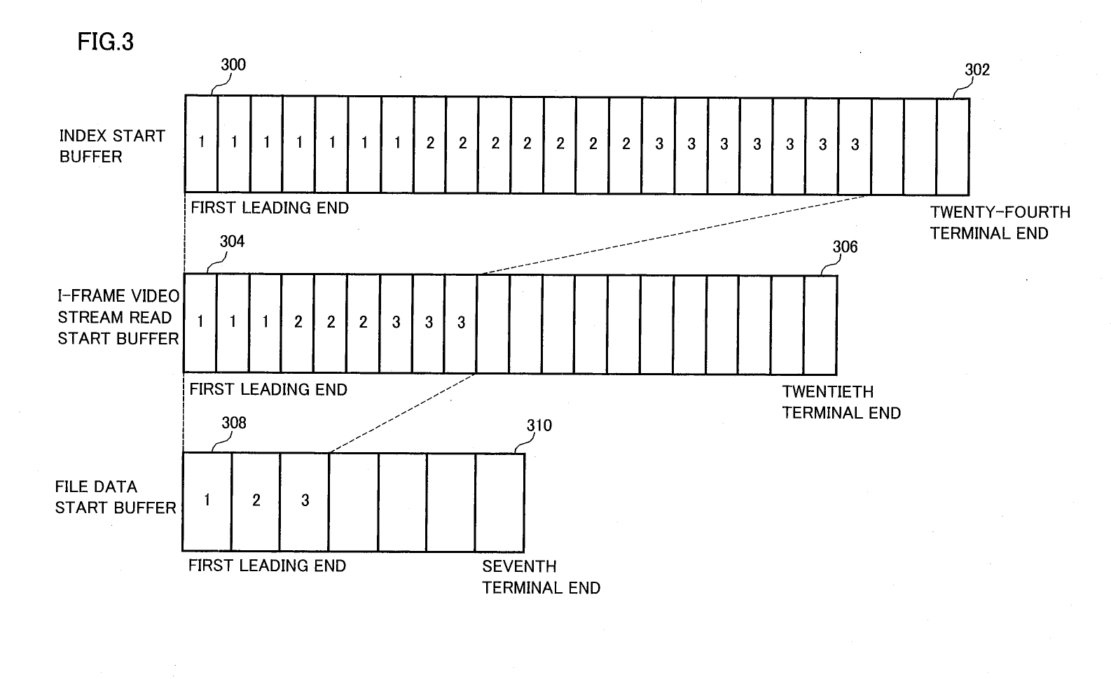

As described above, the index start buffer, the I-frame video stream read start buffer and the file data start buffer each allocated to SDRAM 32 are used for executing the sequential motion picture continuous reproduction process. With reference to FIGS. 3 to 5, hereinafter, description will be given of a data storage status of each buffer in a case of continuously reproducing five motion picture files in sequence.

FIG. 3 shows the data storage statuses in the index start buffer, the I-frame video stream read start buffer and the file start buffer upon completion of the write of the information in the motion picture file by the predetermined number (e.g., 3) after reception of the sequential motion picture continuous reproduction command. In FIG. 3, “1”, “2”, . . . each indicate a number of a motion picture file to be reproduced. In the sequential motion picture continuous reproduction process, the oldest motion picture file has the number of “1”, the second oldest motion picture file subsequent thereto has the number of “2”, and the third oldest motion picture file subsequent thereto has the number of “3”.

In the index start buffer, the index information data including seven data blocks is stored for each motion picture file. In the I-frame video stream read start buffer, the I-frame data including three data blocks is stored for each motion picture file. The number of data blocks in the index information and the I-frame to be stored differ depending on the data amount in the motion picture file; however, the configuration described above is used for convenience of description. In the file data start buffer, the compressed motion picture data including one data block is stored for each motion picture file.

In this implementable example, the index start buffer has data block regions capable of storing at most 24 data blocks. With reference to FIG. 3, twenty-fourth data block region 302 serves as a terminal end and first data block region 300 serves as a leading end. The index start buffer is a ring buffer as described above. Therefore, when the data block of the index information is stored in twenty-fourth data block region 302, the data block subsequent thereto is stored in leading (first) data block region 300.

Likewise, in the I-frame video stream read start buffer, when the data block of the I-frame data is stored in twentieth data block region 306, the data block subsequent thereto is stored in leading (first) data block region 304. Similarly, in the file data start buffer, when the data block of the compressed motion picture data is stored in seventh data block region 310, the data block subsequent thereto is stored in leading (first) data block region 308.

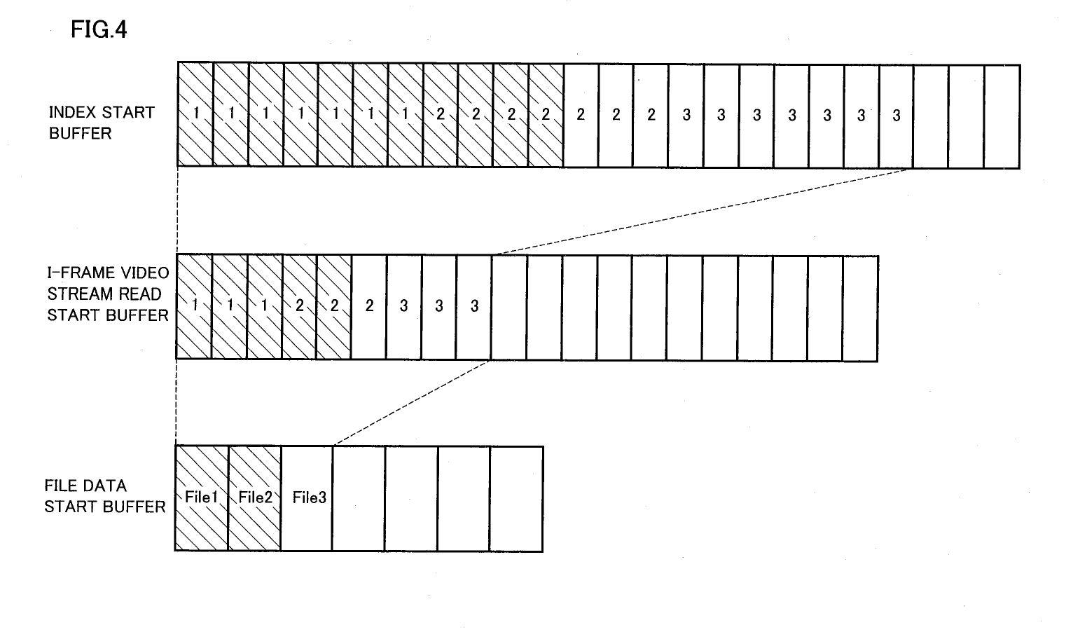

FIG. 4 shows the data storage status of each buffer in the case of reproducing the compressed motion picture data in the motion picture file “2” (the second oldest motion picture file) in the motion picture continuous reproduction mode.

In FIG. 4, a hatched data block indicates a data block having been reproduced. With reference to FIG. 4, the motion picture file “1” (i.e., the oldest motion picture file) and a portion of the motion picture file “2” (i.e., the second oldest motion picture file) have already been reproduced.

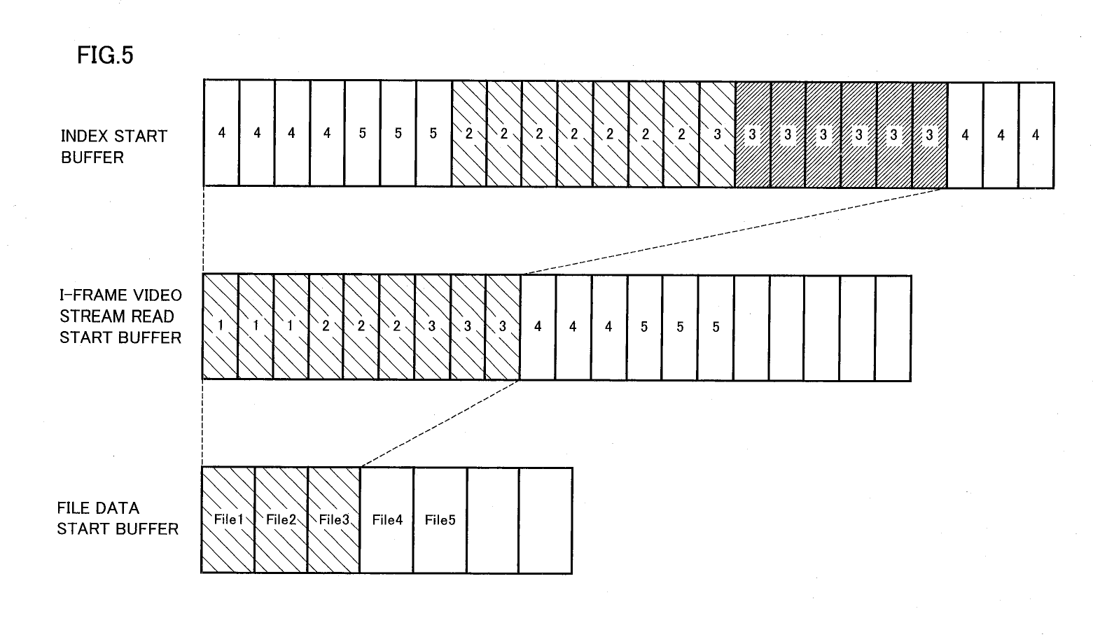

FIG. 5 shows the data storage status of each buffer in the case of reproducing the compressed motion picture data in the motion picture file “3” (i.e., the third oldest motion picture file) in the motion picture continuous reproduction mode. As in the case shown in FIG. 4, a hatched data block indicates a data block having been reproduced and a dotted data block is provided so as to serve as a margin. The index information in the reproduced motion picture file “1” and the index information in the reproduced motion picture file “2” are overwritten with the index information in the motion picture file “4” to be reproduced subsequent to the motion picture file “3” and the index information in the motion picture file “5” to be reproduced subsequent to the motion picture file “4”.

In this implementable example, when receiving a sequential motion picture continuous reproduction command, the image reproducing apparatus opens a plurality of motion picture files and writes information into the relevant buffer in sequence. The image reproducing apparatus sequentially opens the motion picture file by the predetermined number and writes information in the relevant buffer. Thereafter, the image reproducing apparatus opens subsequent motion picture files one by one and writes information into the relevant buffer.

As described above, moreover, the margin prevents index information, which has not processed yet from being overwritten with index information to be written sequentially, in the sequential motion picture continuous reproduction process. Thus, it is possible to reduce a frequency of rewrite into the index start buffer in the backward motion picture continuous reproduction process.

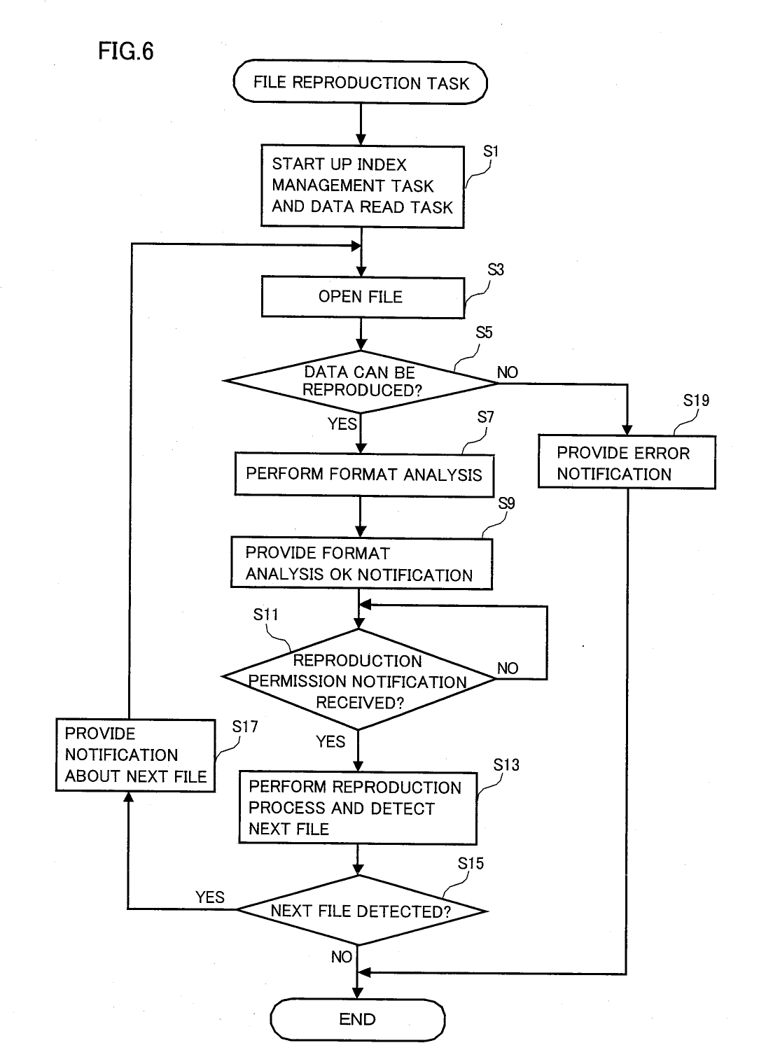

With reference to FIGS. 6 to 8, next, description will be given of the sequential motion picture continuous reproduction process in CPU 22. In this process, as described above, the plurality of tasks, i.e., the file reproduction task, the index management task and the data read task are executed in parallel under the control by the multi-task OS.

With reference to the flowchart in FIG. 6, first, description will be given of the flow of the file reproduction task. When the sequential motion picture continuous reproduction command is input to digital camera 10, the file reproduction task is executed. In step S1, first, CPU 22 starts up the index management task and the data read task (each will be described later). Next, the procedure proceeds to step S3. In step S3, CPU 22 controls external memory card control circuit 30 to open the motion picture file as a target of reproduction, which is recorded in external memory card 36, in order to read out the header information from the motion picture file. Next, the procedure proceeds to step S5. In step S5, CPU 22 determines whether or not the motion picture file can be reproduced, i.e., whether or not the motion picture file is corrupt, and also determines whether or not the motion picture file is an MP4 format file. If NO in step S5, the procedure proceeds to step S19. In step S19, CPU 22 provides error notification to the index management task and the data read task, and terminates the file reproduction task.

If YES in step S5, CPU 22 performs format analysis on the motion picture file, based on the header information in the motion picture file. Next, the procedure proceeds to step S9. In step S9, CPU 22 provides format analysis OK notification to the index management task and the data read task. Next, the procedure proceeds to step S11. In step S11, CPU 22 determines whether or not to receive reproduction permission notification from the data read task. CPU 22 repeatedly performs the determination until receiving the reproduction permission notification. If YES in step S11, the procedure proceeds to step S13. In step S13, CPU 22 controls MPEG codec 28 to extend the compressed motion picture data stored in the file data start buffer. CPU 22 stores the digital extended image signal in SDRAM 32 again, and causes LCD 38 to display the image signal based on the digital extended image signal. In other words, CPU 22 performs the reproduction process. In step S13, moreover, CPU 22 detects the motion picture file to be reproduced next while performing the reproduction process. Next, the procedure proceeds to step S15.

In step S15, CPU 22 determines whether or not the motion picture file to be reproduced next can be detected. If YES in step S15, the procedure proceeds to step S17. In step S17, CPU 22 provides, to the index management task and the data read task, notification about the motion picture file to be reproduced next. Then, the procedure returns to step S3. In step S3, CPU 22 opens the motion picture file to be reproduced next. If NO in step S15, CPU 22 terminates the file reproduction task.

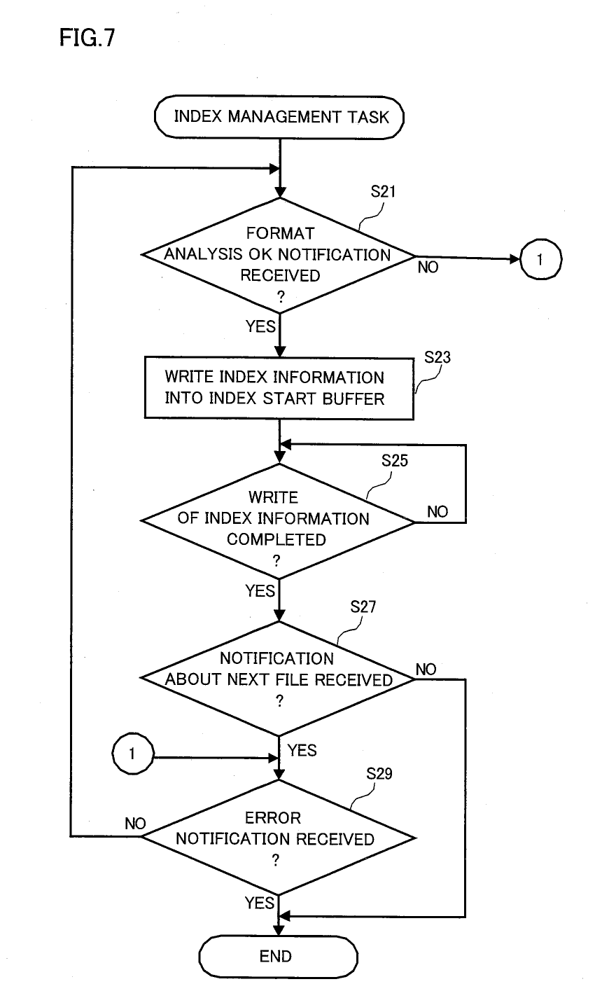

With reference to the flowchart in FIG. 7, next, description will be given of the flow of the index management task. CPU 22 starts up the index management task in the file reproduction task. In step S21, CPU 22 determines whether or not to receive the format analysis OK notification from the file reproduction task. If NO in step S21, the procedure proceeds to step S29. In step S29, CPU 22 determines whether or not to receive the error notification from the file reproduction task. If NO in step S29, the procedure returns to step S21. If YES in step S21, the procedure proceeds to step S23. In step S23, CPU 22 writes the index information into the index start buffer. Next, the procedure proceeds to step S25. In step S25, CPU 22 determines whether or not the index information in the motion picture file is written into the index start buffer by the predetermined number. CPU 22 repeatedly performs the determination until the index information in the motion picture file is written into the index start buffer by the predetermined number.

If YES in step S25, the procedure proceeds to step S27. In step S27, CPU 22 determines whether or not to receive, from the file reproduction task, the notification about the motion picture file to be reproduced next. If YES in step S27, the procedure proceeds to step S29. In step S29, CPU 22 determines whether or not to receive the error notification from the file reproduction task. If NO in step S29, the procedure returns to step S21. If NO in step S27 and if YES in step S29, CPU 22 terminates the index management task.

In step S25, CPU 22 determines whether or not the index information in the motion picture file is written into the index start buffer by the predetermined number. In the first turn of this flow since the reception of the sequential motion picture continuous reproduction command, this predetermined number is 2 or more. In the second and subsequent turns, this predetermined number is 1.

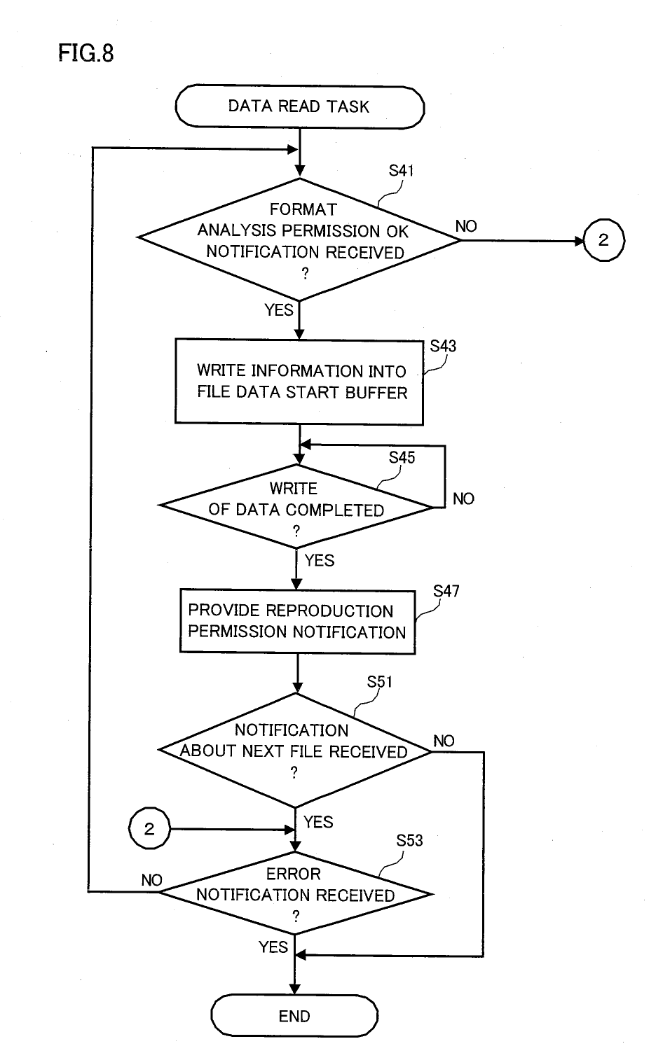

With reference to the flowchart in FIG. 8, next, description will be given of the flow of the data read task. CPU 22 starts up the data read task in the file reproduction task. In step S41, CPU 22 determines whether or not to receive the format analysis OK notification from the file reproduction task. If NO in step S41, the procedure proceeds to step S53. In step S53, CPU 22 determines whether or not to receive the error notification from the file reproduction task. If NO in step S53, the procedure returns to step S41.

If YES in step S41, CPU 22 controls external memory card control circuit 30 to sequentially write the video data information (GOP basis) and the audio data information each concerning the compressed motion picture data in the motion picture file recorded in external memory card 36 by the predetermined number, into the file data start buffer, on the data block basis. Next, the procedure proceeds to step S45. In step S45, CPU 22 determines whether or not the compressed motion picture data in the motion picture file is written into the file data start buffer by the predetermined number. If YES in step S45, the procedure proceeds to step S47. In step S47, CPU 22 provides reproduction permission notification to the file reproduction task.

Next, the procedure proceeds to step S51. In step S51, CPU 22 determines whether or not to receive, from the file reproduction task, the notification about the motion picture file to be reproduced next. If YES in step S51, the procedure proceeds to step S53. In step S53, CPU 22 determines whether or not to receive the error notification from the file reproduction task. If NO in step S53, the procedure returns to step S41. If NO in step S51 and if YES in step S53, CPU 22 terminates the data read task.

In step S45, CPU 22 determines whether or not the compressed motion picture data in the motion picture file is written into the file data start buffer by the predetermined number. In the first turn of this flow since the reception of the sequential motion picture continuous reproduction command, this predetermined number is 2 or more. In the second and subsequent turns, this predetermined number is 1.

As will be clear from the foregoing description, when digital camera 10 as this implementable example receives the sequential motion picture continuous reproduction command, CPU 22 sequentially opens the motion picture file to be reproduced by the predetermined number, and sequentially writes the index information, the I-frame data and the compressed motion picture data into the index start buffer, the I-frame video stream read start buffer and the file data start buffer in SDRAM 32, respectively. When the information in the motion picture file have been written into the relevant buffer by the predetermined number, CPU 22 reproduces the compressed motion picture data stored in the file data start buffer. In this reproduction process, moreover, CPU 22 opens the motion picture file including the information to be written into the relevant buffer next, and writes the information into the relevant buffer in sequence. As a result, the data required in the process for reproducing the subsequent motion picture file is constantly stored in the relevant buffer. This configuration allows seamless reproduction.

In this implementable example, CPU 22 reproduces a plurality of motion picture files, which are recorded in external memory card 38, in sequence from the oldest one to the latest one in the sequential motion picture continuous reproduction mode. However, an order to reproduce the motion picture file may be arbitrarily selected by the user. CPU 22 may continuously reproduce a plurality of motion picture files which are arbitrarily ordered by the user.

In this implementable example, upon reproduction of a motion picture file, CPU 22 determines whether or not this file can be reproduced, based on whether or not this file is an MP4 format file. Alternatively, CPU 22 may determine whether or not this file can be reproduced, based on whether or not this file is a file in a format which can be reproduced by digital camera 10, rather than the MP4 format file.

In this implementable example, the CMOS imager unit of digital camera 10 captures an optical image of a subject. Alternatively, a CCD imager may be employed for capturing the optical image of the subject.

In this implementable example, CPU 22 causes LCD 38 to display the digital image signal or the image signal based on the digital extended image signal. Alternatively, an organic EL may be employed for displaying the image signal.

In this implementable example, the external memory card records therein a motion picture file to be reproduced. Alternatively, an HDD may be employed for recording the motion picture file.

In this implementable example, freeze-frame picture data is compressed in JPEG format, but may be compressed in TIFF format or GIF format. Moreover, a motion picture file is compressed in MP4 format, but may be compressed in MOTION-JPEG format.

In this implementable example, the index start buffer, the I-frame video stream read start buffer and the file data start buffer are provided in the single SDRAM. Alternatively, digital camera 10 may include a plurality of SDRAMs, and the plurality of buffers described above may be provided in the plurality of SDRAMs, respectively.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image reproducing apparatus which continuously reproduces a plurality of image data in a plurality of motion picture files each including at least header information and said image data, the image reproducing apparatus comprising:
a memory which stores said plurality of motion picture files;
an image reproducing controller which performs an analyzing operation to analyze said motion picture file stored in said memory, based on said header information;
a first buffer which stores a result of analysis about said motion picture file, wherein said image reproducing controller performs a reading operation to read out said image data from said motion picture file stored in said memory; and
a second buffer which stores said read out image data, wherein said image reproducing controller performs a reproducing operation to reproduce said image data stored in said second buffer, based on said result of analysis stored in said first buffer, wherein said image reproducing controller performs a timing operation to control a timing to start the analysis of said motion picture file and a timing to start the readout of said image data, wherein
said timing operation includes control of said analyzing operation and said reading operation such that during reproduction of said image data by said reproducing operation, said analyzing operation starts to analyze said motion picture file including said image data to be reproduced next and said reading operation starts to read out said image data.

2. The image reproducing apparatus according to claim 1, wherein said image reproducing controller performs said analyzing operation, said reading operation and said reproducing operation in parallel.

3. The image reproducing apparatus according to claim 1, wherein
said first buffer is a ring buffer.

4. An image reproducing apparatus which continuously reproduces a plurality of image data in a plurality of motion picture files each including at least header information and said image data, the image reproducing apparatus comprising:
a memory which stores said plurality of motion picture files;
an image reproducing controller which performs an analyzing operation to analyze said motion picture file stored in said memory, based on said header information;
a first buffer which stores a result of analysis about said motion picture file, wherein said image reproducing controller performs a reading operation to read out said image data from said motion picture file stored in said memory;
a second buffer which stores said read out image data, wherein said image reproducing controller performs
i) a reproducing operation to reproduce said image data stored in said second buffer, based on said result of analysis stored in said first buffer;
ii) a receiving operation to receive a command to continuously reproduce said plurality of motion picture files; and
iii) a timing operation to control a timing to start the analysis of said motion picture file and a timing to start the readout of said image data, wherein
said timing operation includes control of said analyzing operation and said reading operation such that said analyzing operation starts to analyze said plurality of motion picture files including said plurality of image data to be reproduced continuously and said reading operation starts to read out the image data in a sequential manner, based on a capacity of said first buffer or said second buffer, in response to the reception of said command.

5. The image reproducing apparatus according to claim 4, wherein said image reproducing controller performs said analyzing operation, said reading operation and said reproducing operation in parallel.

6. The image reproducing apparatus according to claim 4, wherein
said first buffer is a ring buffer.

7. An image reproducing method in an image reproducing apparatus including a memory and a processor, the image reproducing method comprising the steps of:
storing, in said memory, a plurality of motion picture files each including at least header information and image data;
analyzing, by said processor, said motion picture file stored in said memory, based on said header information;
storing, by said processor, a result of analysis about said motion picture file in a first buffer;
reading out, by said processor, the image data from said motion picture file stored in said memory;
storing, by said processor, said read out image data in a second buffer;
reproducing, by said processor, said image data stored in said second buffer, based on said result of analysis stored in said first buffer; and
while reproducing said image data, starting to analyze, by said processor, said motion picture file including said image data to be reproduced next and starting to read out the image data.

8. The image reproducing method according to claim 7, wherein said processor executes said step of analyzing, said step of reading and said step of reproducing in parallel.

9. The image reproducing method according to claim 7, wherein
said first buffer is a ring buffer.
